(19) United States
(12) Patent Application Publication
(10) Pub. No.: US 2019/0261048 A1
(43) Pub. Date: Aug. 22, 2019

(54) Set-Top Box with Enhanced Functionality and System and Method for Use of Same

(71) Applicant: Enseo, Inc., Richardson, TX (US)

(72) Inventors: Vanessa Ogle, Fairview, TX (US); Edward H. Wolfe, Plano, TX (US)

(21) Appl. No.: 16/400,959

(22) Filed: May 1, 2019

Related U.S. Application Data
(63) Continuation of application No. 16/034,512, filed on Jul. 13, 2018, now abandoned.
Application No. 16/034,512 is a continuation of application No. 15/694,096, filed on Sep. 1, 2017, now abandoned.
Application No. 15/694,096 is a continuation-in-part of application No. 16/351,893, filed on Mar. 13, 2019.
Application No. 16/351,893 is a continuation of application No. 16/181,470, filed on Nov. 6, 2018.
Application No. 16/181,470 is a continuation of application No. 15/824,766, filed on Nov. 28, 2017, now Pat. No. 10,123,056.
Application No. 15/824,766 is a continuation of application No. 15/417,554, filed on Jan. 27, 2017, now Pat. No. 9,832,489.
Application No. 15/417,554 is a continuation of application No. 15/074,067, filed on Mar. 18, 2016, now Pat. No. 9,560,388.
Application No. 15/074,067 is a continuation of application No. 14/803,428, filed on Jul. 20, 2015, now Pat. No. 9,326,009.
Application No. 14/803,428 is a continuation of application No. 14/294,123, filed on Jun. 2, 2014, now Pat. No. 9,088,828.
(60) Provisional application No. 62/532,443, filed on Jul. 14, 2017.
(60) Provisional application No. 62/505,396, filed on May 12, 2017.
(60) Provisional application No. 61/829,932, filed on May 31, 2013.

(51) Int. Cl. H04N 21/439; H04N 21/214; G10L 15/22; H04N 21/485; H04N 21/41; H04N 21/422; G10L 15/18; G10K 11/178

(52) U.S. Cl. CPC H04N 21/4394; H04N 21/2143; G10L 15/22; H04N 21/4852; G06F 3/167; H04N 21/42203; G10L 15/1815; G10K 11/178; H04N 21/4131

(57) ABSTRACT

A set-top box with enhanced functionality and a system and method for use of the same are disclosed. In one embodiment of the set-top box, a housing secures a television input, a television output, a processor, memory, storage, an audio input unit, and an active sound control circuit portion interconnectively therein. The set-top box provides a visual prompt that is shown on the display. The set-top box utilizes the active sound control circuit portion to generate a processed audio signal by analyzing an external audio signal received at the audio input unit against an internal audio source signal component of a source signal to evaluate the processed audio signal for a spoken sequence of words to validate a meaning with respect to the visual prompt.

### PRIORITY STATEMENT & CROSS-REFERENCE TO RELATED APPLICATIONS

This application is a continuation of co-pending U.S. patent application Ser. No. 16/034,512 entitled “Set-Top Box with Enhanced Functionality and System and Method for Use of Same” filed on Jul. 13, 2018, in the names of Vanessa Ogle et al.; which claims priority from U.S. Patent Application Ser. No. 62/532,443, entitled “Set-Top Box with Enhanced Functionality and System and Method for Use of Same,” filed on Jul. 14, 2017, in the names of Vanessa Ogle et al.; which claims priority from U.S. patent application Ser. No. 15/694,096, entitled “Set-Top Box with Enhanced Functionality and System and Method for Use of Same,” filed on Sep. 1, 2017, in the names of Vanessa Ogle et al.; which claims priority from U.S. Patent Application No. 62/505,396, entitled “Set-Top Box with Enhanced Functionality and System and Method for Use of Same,” filed on May 12, 2017, in the names of Vanessa Ogle et al. This application is also a continuation-in-part of co-pending U.S. patent application Ser. No. 16/351,893 entitled “Set-Top Box with Interactive Portal and System and Method for Use of Same” filed on Mar. 13, 2019 in the names of Vanessa Ogle et al; which is a continuation of U.S. patent application Ser. No. 16/181,470 entitled “Set-Top Box with Interactive Portal and System and Method for Use of Same” filed on Nov. 6, 2018, in the names of Vanessa Ogle et al.; which is a continuation of U.S. patent application Ser. No. 15/824,766 entitled “Set-Top Box with Interactive Portal and System and Method for Use of Same” filed on Nov. 28, 2017, in the names of Vanessa Ogle et al., now U.S. Pat. No. 10,123,056 issued on Nov. 6, 2018; which is a continuation of U.S. patent application Ser. No. 15/417,554 entitled “Set-Top Box with Interactive Portal and System and Method for Use of Same” filed on Jan. 27, 2017, in the names of Vanessa Ogle et al., now U.S. Pat. No. 9,832,489 issued on Nov. 28, 2017; which is a continuation of U.S. patent application Ser. No. 15/074,067 entitled “Set-Top Box with Interactive Portal and System and Method for Use of Same” filed on Mar. 18, 2016, in the names of Vanessa Ogle et al., now U.S. Pat. No. 9,560,388 issued on Jan. 31, 2017; which is a continuation of U.S. patent application Ser. No. 14/803,428 entitled “Set-Top Box with Interactive Portal and System and Method for Use of Same” filed on Jul. 20, 2015, in the names of Vanessa Ogle et al., now U.S. Pat. No. 9,326,009 issued on Apr. 26, 2016; which is a continuation of U.S. patent application Ser. No. 14/294,123 entitled “Set-top Box with Interactive Portal and System and Method for Use of Same” filed on Jun. 2, 2014, in the names of Vanessa Ogle et al., now U.S. Pat. No. 9,088,828 issued on Jul. 21, 2015; which claims priority from U.S. Patent Application Ser. No. 61/829,932 entitled “On-Screen Display” filed on May 31, 2013 in the name of Vanessa Ogle; all of which are hereby incorporated by reference for all purposes.

### TECHNICAL FIELD OF THE INVENTION

This invention relates, in general, to set-top boxes and, in particular, to set-top boxes with enhanced functionality and controls and systems and methods for use of the same that address and enhance the content typically received from an external signal source and provided to a display, such as a television.

### BACKGROUND OF THE INVENTION

Without limiting the scope of the present invention, the background will be described in relation to televisions in the hospitality lodging industry, as an example. To many individuals, a television is more than just a display screen, rather it is a doorway to the world, both real and imaginary, and a way to experience new possibilities and discoveries. To enhance the experience, consumers are desiring televisions with enhanced content in an easy-to-use platform. As a result of such consumer preferences, the quality of content and ease-of-use of televisions are frequent differentiators in determining the experience of guests staying in hospitality lodging establishments. Accordingly, there is a need for improved systems and methods for providing televisions with enhanced content in an easy-to-use platform in the hospitality lodging industry.

### SUMMARY OF THE INVENTION

It would be advantageous to achieve a set-top box that would improve upon existing limitations in functionality. It would also be desirable to enable a computer-based electronics and software solution that would provide a television or other display with enhanced content in an easy-to-use platform in the hospitality lodging industry or in another environment. To better address one or more of these concerns, a set-top box with enhanced functionality and controls and a system and method for use of the same are disclosed. In one embodiment of the set-top box, a housing secures a television input, television output, a processor, memory, an audio input unit, an active sound control circuit portion, and a speech processing circuit portion, interconnectively therein.

The set-top box receives a source signal from an external source and forwards a fully tuned audiovisual signal to a display and a speaker based on the source signal. The set-top box provides a visual prompt that is shown on the display. The set-top box utilizes the active sound control circuit portion to generate a processed audio signal by analyzing an external audio signal received at the audio input unit against an internal audio source signal component of a source signal to evaluate the processed audio signal for a spoken sequence of words to validate a meaning with respect to the visual prompt. Based on the validated memory, a command signal may be entered to control the display, an amenity, or request a service, for example. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing a set-top box having enhanced functionality and control thereon according to the teachings presented herein;

FIG. 2A is a schematic diagram depicting one embodiment of a display depicted in FIG. 1, under control of the set-top box, exhibiting exemplary enhanced functionality;

FIG. 2B is a schematic diagram depicting one embodiment of the display depicted in FIG. 1, under control of the set-top box, exhibiting exemplary enhanced functionality;

FIG. 2C is a schematic diagram depicting one embodiment of the display depicted in FIG. 1, under control of the set-top box, exhibiting exemplary enhanced functionality;

FIG. 2D is a schematic diagram depicting one embodiment of the display depicted in FIG. 1, under control of the set-top box, exhibiting exemplary enhanced functionality;

FIG. 2E is a schematic diagram depicting one embodiment of a display depicted in FIG. 1, under control of the set-top box, exhibiting exemplary enhanced functionality;

FIG. 2F is a schematic diagram depicting one embodiment of the display depicted in FIG. 1, under control of the set-top box, exhibiting exemplary enhanced functionality;

FIG. 3A is a wall-facing exterior elevation view of one embodiment of the set-top box depicted in FIG. 1 in further detail;

FIG. 3B is a television-facing exterior elevation view of the set-top box depicted in FIG. 3A;

FIG. 3C is a front perspective view of a dongle depicted in FIG. 1 in further detail;

FIG. 4 is a functional block diagram depicting one embodiment of the set-top box presented in FIGS. 3A and 3B;

FIG. 5A is a schematic block diagram depicting one operational embodiment of the set-top box presented in FIG. 1;

FIG. 5B is a schematic block diagram depicting another operational embodiment of the set-top box presented in FIG. 1;

FIG. 5C is a schematic block diagram depicting one further operational embodiment of the set-top box presented in FIG. 1;

FIG. 5D is a schematic block diagram depicting still another operational embodiment of the set-top box presented in FIG. 1; and

FIG. 6 is a flow chart depicting one embodiment of a method for providing a set-top box having enhanced functionality and control according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

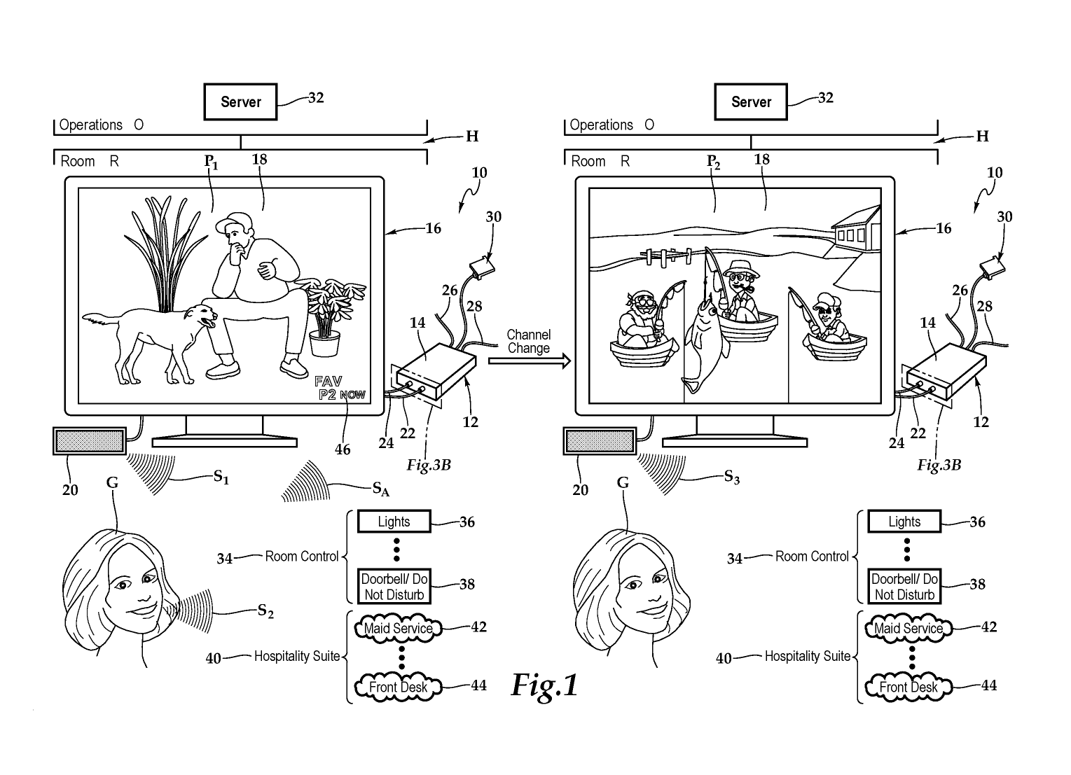

Referring initially to FIG. 1, therein is depicted one embodiment of a system 10 utilizing a set-top box 12 with enhanced functionality and control capabilities being employed within a hospitality lodging establishment H. The hospitality lodging establishment or, more generally, hospitality property, may be a furnished multi-family residence, dormitory, lodging establishment, hotel, hospital, or other multi-unit environment. As shown, by way of example and not by way of limitation, the hospitality environment is depicted as a hotel having various rooms, including room R and back of the house operations O. The set-top box 12 includes a housing 14 and is communicatively disposed with various amenities associated within the hospitality lodging establishment H, including a display 16 having a screen 18 and a speaker 20, which may be separate from the display 16 or fully integrated therewith. Set-top boxes, like the set-top box 12, may be deployed throughout the rooms R of the hospitality lodging establishment H.

As shown, in one embodiment, within the room R, the system 10 includes the set-top box 12 and the display 16 having the screen 18. The display 16 may be a television or any form of electronic visual display device. A connection, which is depicted as an HDMI connection 22, connects the set-top box 12 to the display 16. Other connections include a power cable 24 coupling the set-top box 12 to a power source, a coaxial cable 26 coupling the set-top box 12 to an external cable source, and a category five (Cat 5) cable 28 coupling the set-top box 12 to an external pay-per-view source at the hotel or other lodging establishment, for example. As shown, the set-top box 12 may include a dongle providing particular technology and functionality extensions thereto. That is, the set-top box 12 may be a set-top box-dongle combination in one embodiment. More generally, it should be appreciated that the cabling connected to the set-top box 12 will depend on the environment and application and the cabling connections presented in FIG. 1 are depicted for illustrative purposes. Further, it should be appreciated that the positioning of the set-top box 12 will vary depending on environment and application and, with certain functionality, the set-top box 12 may be placed more discretely behind the display 16. The set-top box may also be disposed in communication with a server, such as server 32, located in operating 0 of the hospitality lodging establishment H.

Room control 34 represents control of various amenities, such as in-room amenities, associated with a user's stay in the hospitality lodging establishment. The various amenities may include lights 36, a thermostat, shades, and a doorbell/do not disturb designation 38. The set-top box 12 is communicatively disposed with these various amenities, which may also include a CD/DVD player, and a radio tuner. Hospitality suite 40 represents a set of services associated with a user's stay in the hospitality lodging establishment H. The various guest services may include check in/check out, maid service 42, spa, room service, and front desk 44. The set-top box 12 is communicatively disposed with these various services.

In operation, the set-top box 12 receives a source signal from an external source and forwards a fully tuned audiovisual signal to the display 16 and the speaker 20 based on the source signal, which may be received from the coaxial cable 26. In one embodiment, as part of the fully tuned audiovisual signal, the set-top box provides instructions for a visual prompt 46 that is shown on the display 16. In one embodiment, the visual prompt 46 provides a visual cue for sounds or speech the guest G should vocalize or utter for a particular command to be executed by the set-top box 12. The set-top box 12 generates a processed audio signal by analyzing an external audio signal SA, which may be a combination of sound S₁ from the speaker 20 and speech S₂ from the guest G, received at set-top box 12 against an internal audio source signal component of the source signal. The internal audio source signal component of the source signal represents the display-speaker sound output signal and Sound S₁. The processed audio signal isolates the speech S₂, which may be analyzed by the set-top box 12 to determine the presence of a command by evaluating the processed audio signal for a spoken sequence of words to validate a meaning with respect to the visual prompt. The spoken sequence of words may be an utterance, vocalization, word, words, or phrase, for example.

By way of example, remote control functionality may be provided by a spoken sequence of words to send a command signal to the display, control an amenity associated with the room R, make a service request associated with the hospitality lodging establishment H, or execute a program via the Internet, for example. As shown in FIG. 1, by way of example, the set-top box 12 provides instructions to the display 16 to show the visual prompt 46 on the display 16. By way of example and not by way of limitation, the visual prompt 46 relates to a favorite program of the guest G being on television on a different channel. The visual prompt 46 provides a visual cue for sounds or speech the guest G should vocalize or utter for a particular command, such as change the channel from the program P₁ to the program P₂, to be executed by the set-top box 12.

The guest G sees the visual prompt 46 on the display 18 and speaks spoken words S₂, such as “Favorite Show” or “P₂,” which are received by the set-top box 12 and translated into a command to change the channel from the program P₁ to the program P₂, which includes sound S₃. Prior to being translated into the command to change the channel, the set-top box 12 utilizes the internal audio source signal component of the source signal to analyze the ambient sound represented by the external audio signal SA to isolate the sound S₂ from the sound S₁.

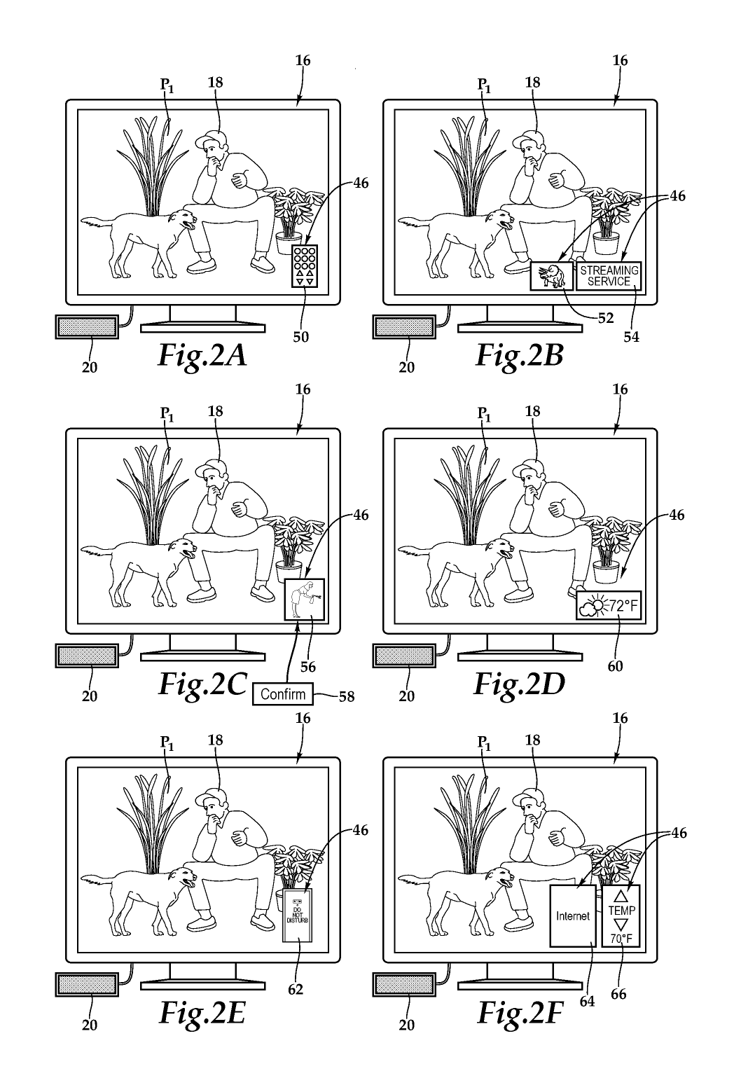

Referring now to FIG. 2A, FIG. 2B, FIG. 2C, FIG. 2D, FIG. 2E, and FIG. 2F, in each of these figures the display 16 includes the screen 18 and the speaker 20. The program P₁ is being shown. Further, in each of these figures, non-limiting examples of a visual prompt 46 are illustrated. As shown in FIG. 2A and FIG. 2B, the instructions for the visual prompt 46, the visual prompt 46, and subsequent command signal from the set-top box 12 may relate to remote control of the display 16. By way of example and not by way of limitation, the visual prompt 46 may provide words, an icon, or a combination thereof. The visual prompt 46 may relate to one or more remote control functions: ON/OFF, dimming/brightness adjustments, channel change, channel up, channel down, searching program, starting an application, navigating an application, searching for a channel, volume increase, volume decrease, set sleep timer, fast forward, rewind, pause, and stop, for example. As shown, an icon 50 represents a remote control and provides a visual cue to the guest for sounds or speech the guest should vocalize or utter for a particular remote control command, such as ON/OFF, dimming/brightness adjustments, channel change, channel up, or channel down, for example. The sounds or speech the guest may vocalize or utter for such a remote control command may be “TV ON” or “Channel UP,” for example.

An icon 52 represents an image of a program and provides a visual cue to the guest for sounds or speech the guest should vocalize or utter for a remote control command, such as go to a particular program now. The sounds or speech the guest may vocalize or utter for such a remote control command may be “Program Now” or the name of the program, for example. Words 54 represent an image of a streaming service and provides a visual cue to the guest for sounds or speech the guest should vocalize or utter for a remote control command, such as executing the streaming service. The sounds or speech the guest may vocalize or utter for such a remote control command may be “Streaming Service” or the name of the streaming service, for example. As shown in FIG. 2A and FIG. 2B, the number of visual prompts 46 on the display 16 may vary. The display 16 of FIG. 2A depicts one visual prompt 46 and the display 16 of FIG. 2B depicts two visual prompts 46.

As shown in FIG. 2C and FIG. 2D, the instructions for the visual prompt 46, the visual prompt 46, and subsequent command signal from the set-top box 12 may relate to a service request within a hospitality lodging establishment. By way of example and not by way of limitation, the visual prompt 46 may provide words, an icon, or a combination thereof. The visual prompt 46 may relate to one or more service request functions: housekeeping, wake up calls, transportation, concierge service, housekeeping service call, flight status, flight time, flight gate number, weather information, checkout, or emergency assistance, for example.

As shown, an icon 56 represents a housekeeping service and provides a visual cue to the guest for sounds or speech the guest should vocalize or utter for a request for housekeeping. The sounds or speech the guest may vocalize or utter for such a remote control command may be “Housekeeping” or refer to a more specific request like towel service or turndown service, for example. In one embodiment, as shown in FIG. 2C, following the sounds or speech form the guest and processing from the set-top box 12, the set-top box may provide instructions for a visual confirmation prompt 58 to be shown on the display 16. The visual confirmation prompt 58 provides a visual cue to the guest for sounds or speech the guest should vocalize or utter a confirmation for a request for housekeeping. The sounds or speech the guest may vocalize or utter for such a remote control command may be “Confirmed,” “Confirmation,” or “Yes,” for example, in order to affirm the visual prompt 46, which in one implementation may include a visual effect, such as blinking or increased brightness or appearance, during the presentation of the confirmation of the request for housekeeping. With reference to FIG. 2D, by way of example, an icon 60 represents a service request for weather information and provides a visual cue to the guest for sounds or speech the guest should vocalize or utter for such a service request. The sounds or speech the guest may vocalize or utter for such a service request may be “Weather,” for example.

As shown in FIG. 2E and FIG. 2F, the instructions for the visual prompt 46, the visual prompt 46, and subsequent command signal from the set-top box 12 may relate to controlling an amenity within the room or hospitality lodging establishment. By way of example and not by way of limitation, the visual prompt 46 may provide words, an icon, or a combination thereof. The visual prompt may relate to one or more amenity command functions: lights, thermostats, shades, and doorbell/do not disturb designations.

As shown in FIG. 2F, an icon 62 represents an amenity and provides a visual cue to the guest for sounds or speech the guest should vocalize or utter to command the door to change the do not disturb designation. The sounds or speech the guest may vocalize or utter for such amenity control may be “Do Not Disturb.” As shown in FIG. 2G, an icon 64 represents Internet access and provides a visual cue to the guest for sounds or speech the guest should vocalize or utter to execute a command on the Internet, such as going to a particular website or conducting a search. The sounds or speech the guest may vocalize or utter for such amenity control may be “Internet.” As also shown in FIG. 2G, an icon 66 represents a thermostat and provides a visual cue to the guest for sounds or speech the guest should vocalize or utter to command the thermostat and change the temperature in the room. The sounds or speech the guest may vocalize or utter for such amenity control may be “Hotter,” “Colder,” or “Set Temperature to 68,” for example.

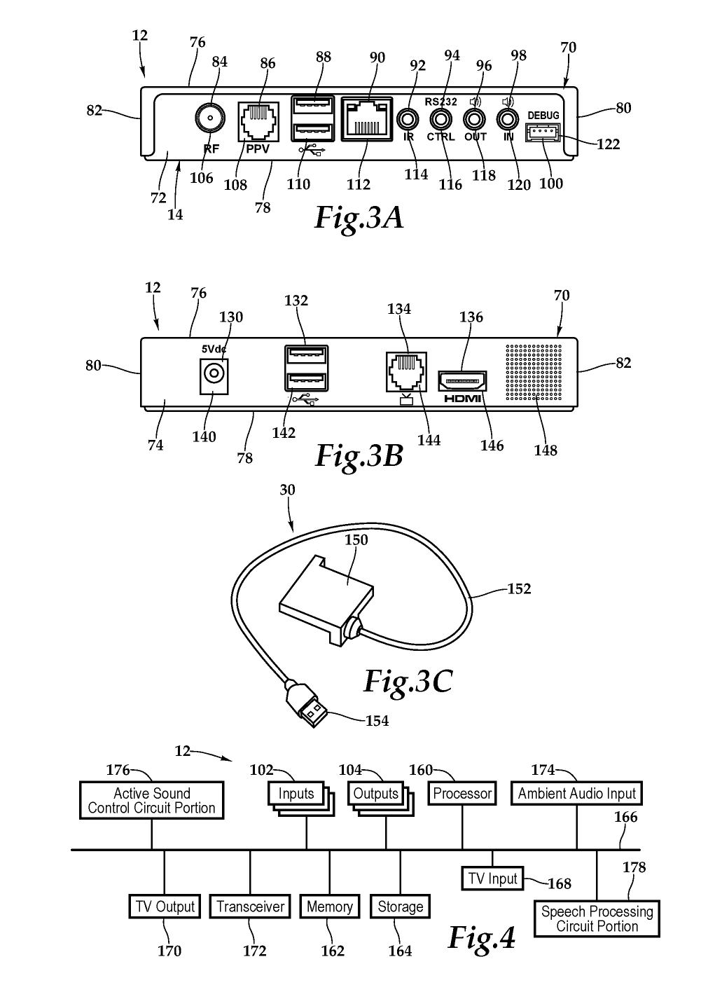

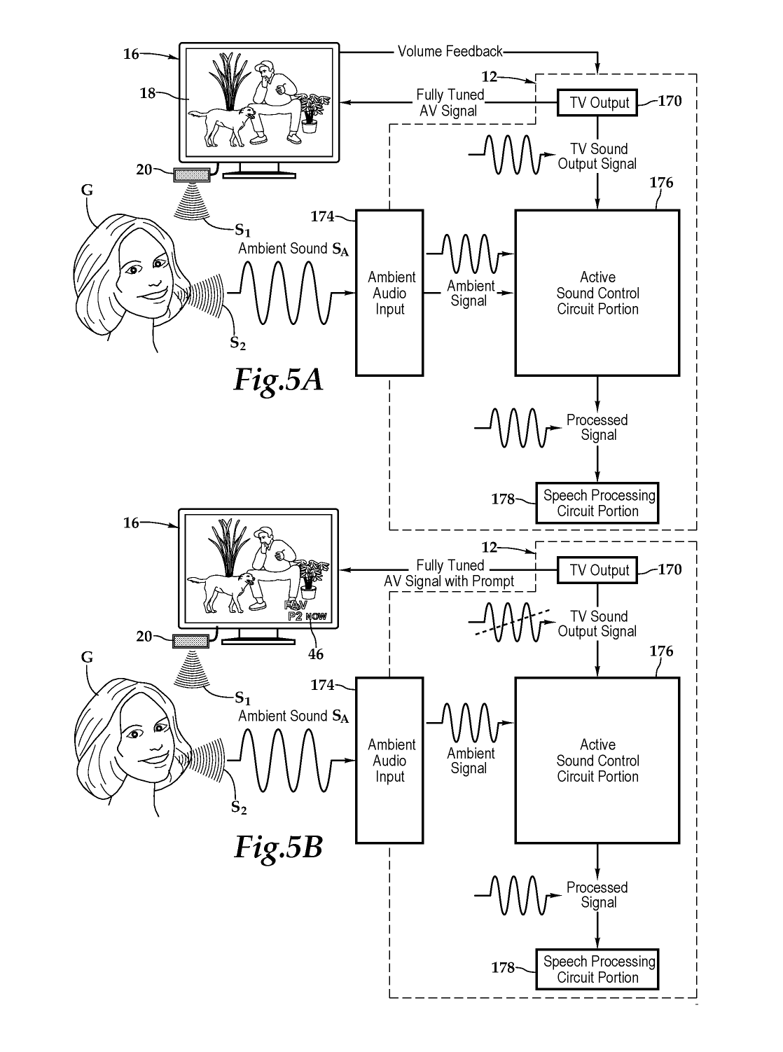

Referring to FIG. 3A, FIG. 3B, FIG. 3C, and FIG. 4, as used herein, set-top boxes, back boxes and set-top/back boxes may be discussed as set-top boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 12 includes a housing 14 having a cover 70 having a rear wall 72, front wall 74, top wall 76, bottom base 78, and two sidewalls 80, 82. It should be appreciated that front wall, rear wall, and side wall are relative terms used for descriptive purposes and the orientation and the nomenclature of the walls may vary depending on application. The front wall includes various ports, ports 84, 86, 88, 90, 92, 94, 96, 98, and 100 that provide interfaces for various interfaces, including inputs and outputs. In one implementation, as illustrated, the ports 84 through 100 include inputs 102 and outputs 104 and, more particularly, an RF input 106, a RJ-45 input 108, universal serial bus (USB) input/outputs 110, an Ethernet category 5 (Cat 5) coupling 112, an internal reset 114, an RS232 control 116, an audio out 118, an audio in 120, and a debug/maintenance port 122. The front wall 74 also includes various inputs 102 and outputs 104. More particularly, ports 130, 132, 134, and 136 include a 5V dc power connection 140, USB inputs/outputs 142, an RJ-45 coupling 144, an HDMI port 146, and a microphone 148. It should be appreciated that the configuration of ports may vary with the set-top box depending on application and context. As previously alluded to, the housing 14 may include a housing-dongle combination including, with respect to the dongle 30, a unit 150 having a cable 152 with a set-top box connector 154 for selectively coupling with the set-top box 12.

Within the housing 14, a processor 160, memory 162, storage 164, the inputs 102, and the outputs 104 are interconnected by a bus architecture 166 within a mounting architecture. It should be understood that the processor 160, memory 162, storage 164, the inputs 102, and the outputs 104 may be entirely contained within the housing 14 or the housing-dongle combination. The processor 160 may process instructions for execution within the computing device, including instructions stored in the memory 162 or in storage 164. The memory 162 stores information within the computing device. In one implementation, the memory 162 is a volatile memory unit or units. In another implementation, the memory 162 is a non-volatile memory unit or units. Storage 164 provides capacity that is capable of providing mass storage for the set-top box 12. The various inputs 102 and outputs 104 provide connections to and from the computing device, wherein the inputs 102 are the signals or data received by the set-top box 12, and the outputs 104 are the signals or data sent from the set-top box 12.

A television content signal input 168 and a television output 170 are also secured in the housing 14 in order to receive content from a source in the hospitality lodging establishment and forward the content, including external content such as cable and satellite and pay-per-view (PPV) programming, to the television located within the hotel room. A transceiver 172 is associated with the set-top box 12 and communicatively disposed with the bus architecture 166. As shown the transceiver 172 may be internal, external, or a combination thereof to the housing. Further, the transceiver 172 may be a transmitter/receiver, receiver, or an antenna for example. Communication between various amenities in the hotel room and the set-top box 12 may be enabled by a variety of wireless methodologies employed by the transceiver 172, including 802.11, 3G, 4G, Edge, WiFi, ZigBee, near field communications (NFC), Bluetooth low energy and Bluetooth, for example. Also, infrared (IR) may be utilized.

An ambient audio input 174, which is coupled to microphone 148, an active sound control circuit portion 176, and a speech processing circuit portion 178 are also secured in the housing 14. Moreover, the ambient audio input 174, the active sound control circuit portion 176, and the speech processing circuit portion 178 are interconnected by the bus architecture 166 within the aforementioned mounting architecture. Within this architecture, the active sound control circuit portion 176 may be at least partially integrated with the processor 160. Similarly, the speech processing circuit portion 178 may be at least partially integrated with the processor 160.

The memory 162 and storage 164 are accessible to the processor 160 and include processor-executable instructions that, when executed, cause the processor 160 to execute a series of operations. The processor-executable instructions cause the processor 160 to send via the television output 170 to the display 16, instructions for a visual prompt 46 that is shown on the display 16. The processor-executable instructions cause the processor 160 to receive an external audio signal at the audio input unit and generate a sound cancellation signal based on the audio source signal component of the source signal. The sound cancellation signal, which represents the sound output of the display 16 and speaker 20, may be generated using the television content signal input 168 or the television output 170, for example, in conjunction with the active sound control circuit portion 176. The processor-executable instructions may cause the processor 160 to receive a volume feedback signal from the display 16 and the speaker 20 and utilize the volume feedback signal to generate the sound cancellation signal or generate the processed audio signal, for example. The processor-executable instructions then cause the processor 160 to utilize the active sound control circuit portion 176 to generate a processed audio signal by analyzing the external audio signal against the audio source signal component of the source signal. As a result, the processor-executable instructions may reduce or cancel the audio source signal component within the ambient sound signal to isolate any speech present.

The memory 162 may include processor-executable instructions that, when executed, further cause the processor to utilize the speech processing circuit portion 178 to evaluate the processed audio signal for a spoken sequence of words to assign a meaning to the spoken sequence of words, and based on the assigned meaning, generate a command signal. The command signal may relate to treating the spoken sequence of words as a voice command for remote control of a display, control of an amenity, request for a service, or execution on the Internet of a command, for example.

The memory 162 may include processor-executable instructions that, when executed, further cause the processor to utilize the speech processing circuit portion 178 to evaluate the processed audio signal for a spoken sequence of words to validate a meaning with respect to the visual prompt 46 and, based on the validated meaning, generate a command signal. The command signal may relate to treating the spoken sequence of words as a voice command for remote control of a display, control of an amenity, request for a service, or execution on the Internet of a command, for example.

In operational embodiments not utilizing the visual prompt 46, with respect to controlling the display 16, the processor 160 may be caused to evaluate the spoken sequence of words to assign a meaning to the spoken sequence of words and then generate a command signal, which is sent to the display 16. With respect to a service request, the processor 160, following evaluation of the spoken words, sends a service request within the hospitality lodging establishment H to an on-property server, for example. With respect to amenity control, the memory 142 includes processor-executable instructions that, when executed cause the processor to be responsive to evaluating the spoken sequence of words, send a command to the particular amenity. A configuration profile is associated with the memory 142 and processor-executable instructions that enables the set-top box 12 to control multiple proximate amenities related to a user's stay in a lodging establishment in a multi-room environment, including the particular amenity to be controlled.

In operational embodiments utilizing the visual prompt, with respect to controlling the display 16, the processor 160 may be caused to evaluate the spoken sequence of words to validate a meaning of the spoken sequence of words with respect to the visual prompt 46 and then generate a command signal, which is sent to the display 16. With respect to a service request, the processor 160, following evaluation of the spoken words, sends a service request within the hospitality lodging establishment to an on-property server, for example. With respect to amenity control, the memory 162 includes processor-executable instructions that, when executed cause the processor 160 to be responsive to evaluating the spoken sequence of words, send a command to the particular amenity. A configuration profile is associated with the memory 162 and processor-executable instructions that enables the set-top box 12 to control multiple proximate amenities related to a user's stay in a lodging establishment in a multi-room environment, including the particular amenity to be controlled. Thus, the systems and methods disclosed herein may enable users to use existing speech as a control to control a display and associated speaker or speakers or amenity via a set-top box. Further, the systems and methods disclosed herein may enable users to use existing speech to request a service or execute a command relative to the Internet. Therefore the systems and methods presented herein avoid the need for additional or expensive high functionality remote controls.

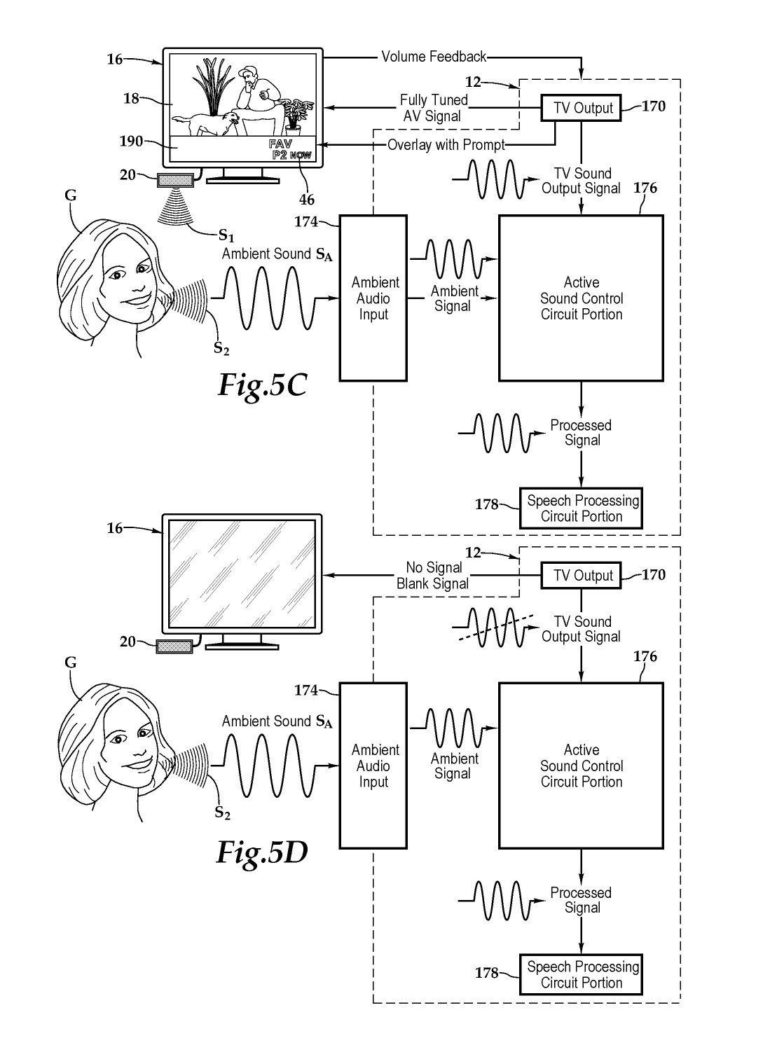

Referring now to FIG. 5A, FIG. 5B, FIG. 5C, and FIG. 5D, one operational embodiment of the set-top box is presented, which focuses on certain components depicted in FIG. 4. Within the busing architecture 166 discussed in FIG. 4, the television output 170, the ambient audio input 174, the active sound control circuit portion 176, and the speech processing circuit portion 178 are interconnected. As previously discussed, the television content signal input 168 receives a source signal from an external source. The source signal may include a visual source signal component and an audio source signal component. Based on the source signal, the television output forwards a fully tuned audiovisual signal to the display 16 and the speaker 20.

The active sound control circuit portion 176 may include analog circuits, digital processing circuits, and combinations thereof. The active sound control circuit portion 176 may include a circuit portion to digitize the external audio signal prior to applying digital signal processing. The active sound control circuit portion 176 may receive the ambient sound SA in order to remove at least a portion of the fully tuned audiovisual signal by way of a noise cancellation stage or noise cancellation loop. The active sound control circuit portion 176 may also receive a volume feedback signal, including volume, from the display 16 and the speaker 20 to further eliminate the TV sound S₁ from the ambient sound SA to isolate the speech S₂. As such, in one aspect, the set-top box 12 may generate a television sound output signal representative of the sound portion of fully tuned AV signal sent to the display 16 and speaker 20. The active sound control circuit portion 176 may receive the ambient signal indicative of the ambient sound SA and the television sound output signal, which represents the audio source signal component of the fully tuned audiovisual signal, in order to remove at least a portion of the television sound conveyed in the ambient sound SA.

As shown in FIG. 5A, FIG. 5B, and FIG. 5C, the display 16 and the speaker 20 are active and the display output signal is provided by the television output 170 to offset the TV sound S₁ and isolate the speech S₂ from the ambient sound SA. On the other hand, in FIG. 5D, the display 16 and the speaker 20 are not active and the display-speaker output signal indicates no sound from the display 16 and the speaker 20.

Continuing to refer to FIG. 5A, FIG. 5B, FIG. 5C, and FIG. 5D, as shown, the active sound control circuit portion 176 generates a processed audio signal by analyzing the ambient signal and display-speaker sound output signal. In FIG. 5A, FIG. 5B, and FIG. 5C, the ambient signal and the display-speaker sound output signal are both present. As shown in FIG. 5D, the ambient signal is present but the display-speaker sound output signal does not have any content. With respect to FIG. 5A, FIG. 5B, FIG. 5C, and FIG. 5D, the processed signal is provided to the speech processing circuit portion 178. In one example, the active sound control circuit portion 176 can reverse at least a portion of the ambient sound SA that is associated with sound S₁, and can generate or otherwise compose an output audio signal that can include the reversed ambient audio. Accordingly, in one aspect, the output processed signal can convey audio data that substantially lacks the ambient television sound S₁ received as part of the ambient sound SA.

The speech processing circuit portion 178 receives the processed audio signal to detect, for example, key words, which may be prompted by the visual prompt 46, and audible commands and any additional audio captured in the recording, and processes the processed audio signal to determine whether the recording corresponds to an utterance of key words as well as any audible command that should be disregarded as being inadvertent. As shown in FIG. 5A, the television output 170 provides a fully tuned AV signal to the display 16. In FIG. 5B, a fully tuned AV signal with a visual prompt 46 is provided and is integrated into the visual source signal component. In FIG. 5C, a fully tuned AV signal with a visual prompt 46 is also provided and here the visual prompt 46 is superimposed over the visual signal component in a superimposed presentation 190. In FIG. 5D, as the display is not activated, no signal or a blank signal is provided from the television output 170 to the display 16.

Continuing to refer to FIG. 5A, FIG. 5B, FIG. 5C, and FIG. 5D, the speech processing circuit portion 178 may access the storage 164 of the set-top box 12 shown in FIG. 4 and compare the captured audio within the processed signal to the stored utterances, whether audible to humans or inaudible to humans, and audio sequences using audio comparison techniques. The speech processing circuit portion 178 may access the storage 164 of the set-top box 12 shown in FIG. 4 and compare the captured audio within the processed signal to specific stored utterances associated with the visual prompt, whether audible to humans or inaudible to humans, and audio sequences using audio comparison techniques. In this regard, the storage 164 of the set-top box 12 may store associations between various visual prompts and utterances to enable validation.

To process the recording/captured key words and audible commands, the speech processing circuit portion 178 may employ audio fingerprinting techniques and other speech/audio comparison techniques. For example, speech processing circuit portion 178 may use audio or acoustic fingerprinting techniques. In this aspect, a digital summary of audio including an inadvertent key word, a prompted key word by way of the visual prompt, or audible command may be generated based on frequency, intensity, time, and other parameters of the audio. This digital summary may then be stored and compared to audio or acoustic fingerprints of captured audio including the key words and/or audible command. In one embodiment, the speech processing circuit portion 178 may include speech recognition capabilities to convert audio to text. The set-top box 12 may compare text resulting from the captured audio to stored text.

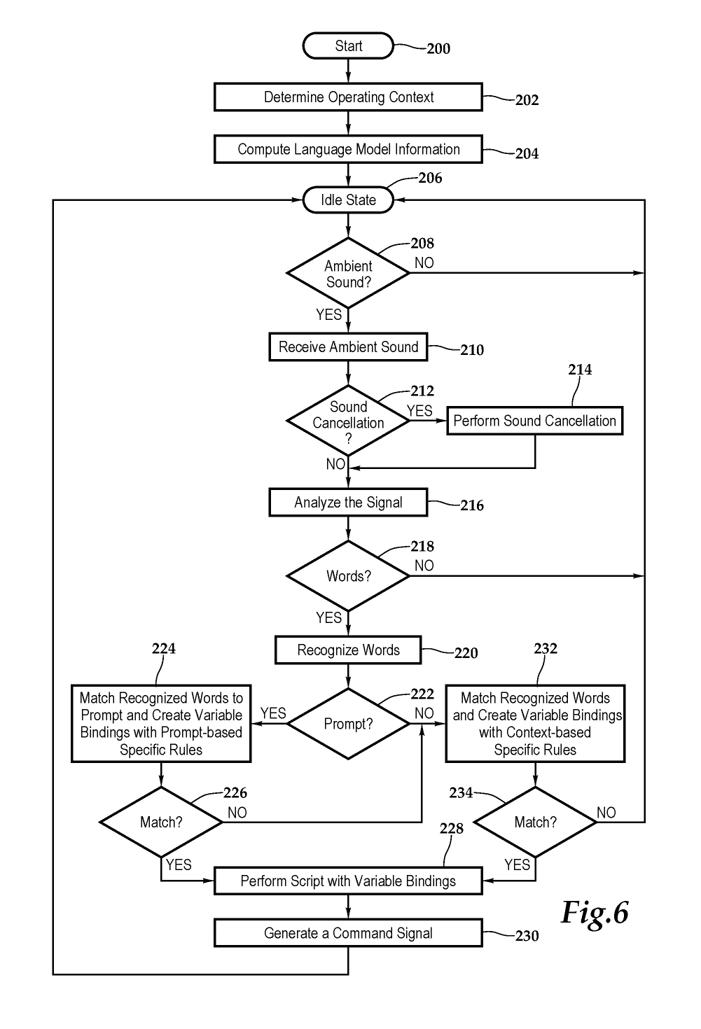

Referring now to FIG. 6, one embodiment of a process flow diagram relating to a method for utilizing set-top boxes with enhanced functionality and controls that address and enhance the content typically received from an external signal source and provided to a display is illustrated. More specifically, the methodology begins at block 200 and with reference to blocks 202 and 204, a current operating context is determined by examining the instructions provided to the set-top box and the display by way of visual prompts. With this context, language model information is determined so that the scope of vocabulary search is defined such that in subsequent steps a determination may be made if any uttered speech matches. At block 206, the language recognition processing is in an idle state prior to obtaining words. As shown at decision block 208, the language recognition processing remains in an idle state until ambient sound is detected.

At block 210, ambient sound is received and at decision block 212, if the sound cancellation functionality is present and activated, then the process advances to block 214 where a sound cancellation signal is generated based on the audio source signal component of a source signal received at the set-top box. The sound cancellation is performed to isolate the sound that is not originating from the display and speakers as provided by the set-top box. At block 216, which follows block 214 and no active sound cancellation functionality from decision block 212, the signal is analyzed for words. At decision block 218, if words are present then the methodology advances to block 220, where the words are recognized. On the other hand, if no words are present then the methodology returns to block 206.

At decision block 222, if a visual prompt is being utilized then the methodology advances to block 224. At block 224, the signal is analyzed for speech. Speech rules which match the recognized utterance are determined. The process of matching a speech rule to an utterance also produces a set of variable bindings with prompt-based specific rules, which represents the meaning of various phrases in the recognized utterance as related to the visual prompt displayed. At decision block 226, the speech rules based on the visual prompt in the system are compared to the guest's utterance to determine if a match is present. If a match is not present, then the process returns to the idle state at block 206. On the other hand, if a match exists, then the process advances to block 228, where a script associated with the speech rules and the variable bindings from the previous steps is executed. The methodology then advances to block 230 where the corresponding command signal is generated.

Returning to decision block 222, if a visual prompt is not being utilized then the methodology advances to block 232. At block 232, the signal is analyzed for speech. Speech rules which match the recognized utterance are determined. The process of matching a speech rule to an utterance also produces a set of variable bindings, which represents the meaning of various phrases in the recognized utterance. At decision block 234, the speech rules in the system are compared to the guest's utterance to determine if a match is present. If a match is not present, then the process returns to the idle state at block 206. On the other hand, if a match exists, then the process advances to block 228 then block 230.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box comprising:
a housing securing a television input, a television output, a processor, memory, storage, an audio input unit, and an active sound control circuit portion therein;
a busing architecture communicatively interconnecting the television input, the television output, the processor, the memory, the storage, the audio input unit, and the active sound control circuit portion;
the television input configured to receive a source signal from an external source, the source signal having a visual source signal component and an audio source signal component;
the television output configured to forward a fully tuned audiovisual signal to a display and a speaker based on the source signal; and
the memory accessible to the processor, the memory including processor-executable instructions that, when executed, cause the processor to:
send via the television output to the display instructions for a visual prompt that is shown on the display,
receive an external audio signal at the audio input unit,
generate a sound cancellation signal based on the audio source signal component of the source signal,
utilize the active sound control circuit portion to generate a processed audio signal by analyzing the external audio signal against the audio source signal component of the source signal,
evaluate the processed audio signal for a spoken sequence of words to validate a meaning with respect to the visual prompt, and
based on the validated meaning, generate a command signal.

2. The set-top box as recited in claim 1, wherein the visual prompt further comprises words.

3. The set-top box as recited in claim 1, wherein the visual prompt further comprises an icon.

4. The set-top box as recited in claim 1, wherein the visual prompt further comprises a combination of words and icons.

5. The set-top box as recited in claim 1, wherein the visual prompt is integrated into the visual source signal component.

6. The set-top box as recited in claim 1, wherein the visual prompt is superimposed over the visual source signal component.

7. The set-top box as recited in claim 1, wherein the command signal provides remote control of the television.

8. The set-top box as recited in claim 7, wherein the remote control comprises an operation selected from the group consisting of ON/OFF, dimming/brightness adjustments, channel change, channel up, channel down, searching program, starting an application, navigating an application, searching for a channel, volume increase, volume decrease, set sleep timer, fast forward, rewind, pause, and stop.

9. The set-top box as recited in claim 1, wherein the memory includes processor-executable instructions that, when executed cause the processor to:
responsive to evaluating the spoken sequence of words, send a command to the particular amenity; and
a configuration profile associated with the memory and processor-executable instructions that enables the set-top box to control a plurality of proximate amenities in a multi-room environment, the plurality of proximate amenities including the particular amenity.

10. The set-top box as recited in claim 1, wherein the plurality of proximate amenities is selected from the group of amenities consisting of lights, thermostats, shades, and doorbell/do not disturb designations.

11. The set-top box as recited in claim 1, wherein the memory includes processor-executable instructions that, when executed cause the processor to:
responsive to evaluating the spoken sequence of words, send a service request within a hospitality lodging establishment.

12. The set-top box as recited in claim 11, wherein the service request is selected from the group of requests consisting of items from housekeeping, wake up calls, transportation, concierge service, housekeeping service call, flight status, flight time, flight gate number, weather information, checkout, and emergency assistance.

13. The set-top box as recited in claim 1, wherein the memory includes processor-executable instructions that, when executed cause the processor to:
responsive to evaluating the spoken sequence of words, treat the spoken sequence of words as a voice command for execution on the Internet.

14. The set-top box as recited in claim 1, wherein the active sound control circuit portion further comprises circuits selected from the group consisting of analog circuits, digital processing circuits, and combinations thereof.

15. The set-top box as recited in claim 1, wherein the active sound control circuit portion further comprises a circuit portion to digitize the external audio signal prior to applying digital signal processing.

16. The set-top box as recited in claim 1, wherein the processor-executable instructions further comprise processor-executable instructions, when executed, cause the processor to:
receive a volume feedback signal indicative of a volume of the fully tuned audiovisual signal at the display and the speaker; and
generate the processed audio signal by utilizing the volume feedback signal.

17. The set-top box as recited in claim 1, wherein the external audio signal further comprises the fully tuned audiovisual signal from the speaker.

18. The set-top box as recited in claim 1, wherein the external audio signal further comprises speech.

19. A set-top box comprising:
a housing securing a television input, a television output, a processor, memory, storage, an audio input unit, and an active sound control circuit portion therein;
a busing architecture communicatively interconnecting the television input, the television output, the processor, the memory, the storage, the audio input unit, and the active sound control circuit portion;
the television input configured to receive a source signal from an external source, the source signal having a visual source signal component and an audio source signal component;
the television output configured to forward a fully tuned audiovisual signal to a display and a speaker based on the source signal; and
the memory accessible to the processor, the memory including processor-executable instructions that, when executed, cause the processor to:
send via the television output to the display instructions for a visual prompt that is shown on the display,
receive an external audio signal at the audio input unit,
evaluate the external audio signal for a spoken sequence of words to validate a meaning with respect to the visual prompt, and
based on the validated meaning, generate a command signal.

20. A set-top box comprising:
a housing securing a television input, a television output, a processor, memory, storage, an audio input unit, and an active sound control circuit portion therein;
a busing architecture communicatively interconnecting the television input, the television output, the processor, the memory, the storage, the audio input unit, and the active sound control circuit portion;
the television input configured to receive a source signal from an external source, the source signal having a visual source signal component and an audio source signal component;
the television output configured to forward a fully tuned audiovisual signal to a display and a speaker based on the source signal; and
the memory accessible to the processor, the memory including processor-executable instructions that, when executed, cause the processor to:
send via the television output to the display instructions for a visual prompt that is shown on the display, the visual prompt relates to control of the display,
receive an external audio signal at the audio input unit,
generate a sound cancellation signal based on the audio source signal component of the source signal,
utilize the active sound control circuit portion to generate a processed audio signal by analyzing the external audio signal against the audio source signal component of the source signal,
evaluate the processed audio signal for a spoken sequence of words to validate a meaning with respect to the visual prompt,
based on the validated meaning, generate a command signal, and
send the command signal to the television.
